(19) United States
(12) Patent Application Publication
(10) Pub. No.: US 2026/0302599 A1
(43) Pub. Date: Oct. 1, 2026

(54) WEARABLE DEVICE

(71) Applicant: Quanta Computer Inc., Taoyuan City (TW)

(72) Inventors: Chu-Yu TANG, Taoyuan City (TW); Chung-Ting HUNG, Taoyuan City (TW); Chun-Yuan WANG, Taoyuan City (TW); Jing-Yao XU, Taoyuan City (TW)

(21) Appl. No.: 19/248,605

(22) Filed: Jun. 25, 2025

(30) Foreign Application Priority Data
Apr. 1, 2025 (TW) 114203241

(51) Int. Cl. H01Q 1/27; H01Q 21/30

(52) U.S. Cl. CPC H01Q 1/273; H01Q 21/30

(57) ABSTRACT

A wearable device includes a first radiation element, a second radiation element, a third radiation element, and a carrier element. The first radiation element has a feeding point. The second radiation element is coupled to the first radiation element. The third radiation element is coupled to the second radiation element. The first radiation element, the second radiation element, and the third radiation element are disposed on the carrier element. An antenna structure is formed by the first radiation element, the second radiation element, and the third radiation element.

### CROSS REFERENCE TO RELATED APPLICATIONS

This application claims priority of Taiwan Patent Application No. 114203241 filed on Apr. 1, 2025, the entirety of which is incorporated by reference herein.

### BACKGROUND OF THE INVENTION

### Field of the Invention

The disclosure relates in general to a wearable device, and in particular, to a wearable device and an antenna structure therein.

### Description of the Related Art

With the advancements being made in mobile communication technology, mobile devices such as portable computers, mobile phones, multimedia players, and other hybrid functional portable electronic devices have become more common. To satisfy consumer demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi systems and using frequency bands of 2.4 GHz, 5.2 GHz, and 5.8 GHz.

According to the direction of research being conducted by major brands, the next generation of emerging mobile devices is likely to be “wearable devices”. For example, wireless communication may be applied to watches, glasses, and even clothes in the future. However, glasses, for example, do not have a large enough space to accommodate antennas for wireless communication. Therefore, this has become a critical challenge for antenna de-signers.

### BRIEF SUMMARY OF THE INVENTION

In an exemplary embodiment, the invention is directed to a wearable device that includes a first radiation element, a second radiation element, a third radiation element, and a carrier element. The first radiation element has a feeding point. The second radiation element is coupled to the first radiation element. The third radiation element is coupled to the second radiation element. The first radiation element, the second radiation element, and the third radiation element are all disposed on the carrier element. An antenna structure is formed by the first radiation element, the second radiation element, and the third radiation element.

In some embodiments, the wearable device is a pair of smart eyeglasses with the wireless communication function.

In some embodiments, the carrier element is the nonconductive temple of the pair of smart eyeglasses.

In some embodiments, the third radiation element is substantially parallel to the first radiation element.

In some embodiments, the second radiation element is substantially perpendicular to the first radiation element and the third radiation element.

In some embodiments, the length of the second radiation element is greater than the length of the first radiation element.

In some embodiments, the length of the first radiation element is greater than the length of the third radiation element.

In some embodiments, the antenna structure covers an operational frequency band, and the operational frequency band is from 2402 MHz to 2482 MHz.

In some embodiments, the total length of the first radiation element, the second radiation element, and the third radiation element is substantially equal to 0.25 wavelength of the operational frequency band.

In some embodiments, the wearable device further includes a main circuit board and a screw element. The main circuit board includes a communication module. The communication module is coupled to the feeding point. The screw element is configured to affix the main circuit board. The distance between the antenna structure and the screw element is from 0.1 mm to 0.125 mm.

### BRIEF DESCRIPTION OF DRAWINGS

The invention can be more fully understood by reading the subsequent detailed description and examples with references made to the accompanying drawings, wherein:

FIG. 1 is a front view of a wearable device according to an embodiment of the invention;

FIG. 2 is a diagram of VSWR (Voltage Standing Wave Ratio) of an antenna structure of a wearable device according to an embodiment of the invention;

FIG. 3 is a perspective view of a wearable device according to an embodiment of the invention;

FIG. 4 is a partial view of a wearable device according to an embodiment of the invention; and

FIG. 5 is another partial view of a wearable device according to an embodiment of the invention.

### DETAILED DESCRIPTION OF THE INVENTION

In order to illustrate the purposes, features and advantages of the invention, the embodiments and figures of the invention are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

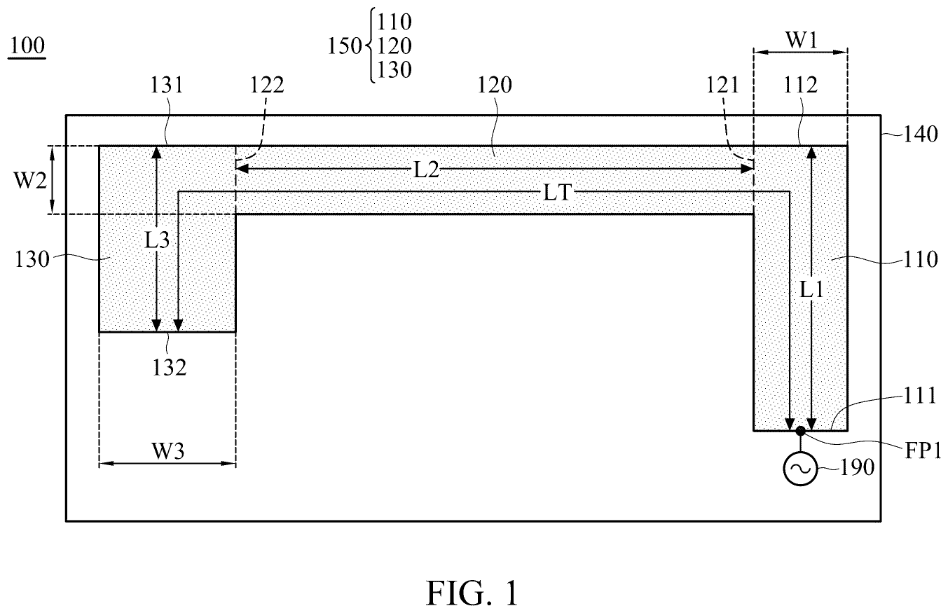

FIG. 1 is a front view of a wearable device 100 according to an embodiment of the invention. As shown in FIG. 1, the wearable device 100 at least includes a first radiation element 110, a second radiation element, 120, a third radiation element 130, and a carrier element 140. The first radiation element 110, the second radiation element 120, and the third radiation element 130 may all be made of metal materials, such as copper, silver, aluminum, iron, or their alloys. In addition, the carrier element 140 may be made of a nonconductive material, such as a plastic material. It should be understood that the wearable device 100 may further include other components, such as a processor, a speaker, a camera element, and/or a battery element, although they are not displayed in FIG. 1.

For example, the first radiation element 110 may substantially have a relatively median straight-line shape. Specifically, the first radiation element 110 has a first end 111 and a second end 112. A feeding point FP1 is positioned at the first end 111 of the first radiation element 110. The feeding point FP1 may be further coupled to a signal source 190. The signal source 190 may be an RF (Radio Frequency) module or a communication module.

For example, the second radiation element 120 may substantially have a relatively long straight-line shape, and the length L2 of the second radiation element 120 may be greater than the length L1 of the first radiation element 110. Specifically, the second radiation element 120 has a first end 121 and a second end 122. The first end 121 of the second radiation element 120 is coupled to the second end 112 of the first radiation element 110. In some embodiments, the second radiation element 120 is substantially perpendicular to the first radiation element 110.

For example, the third radiation element 130 may substantially have a relatively short straight-line shape, and the length L1 of the first radiation element 110 may be greater than the length L3 of the third radiation element 130. Specifically, the third radiation element 130 has a first end 131 and a second end 132. The first end 131 of the third radiation element 130 is coupled to the second end 122 of the second radiation element 120. The second end 132 of the third radiation element 130 is an open end. In some embodiments, the third radiation element 130 is substantially perpendicular to the second radiation element 120, and the third radiation element 130 is substantially parallel to the first radiation element 110. In some embodiments, the third radiation element 130 is coupled through the second radiation element 120 to the first radiation element 110. The combination of the first radiation element 110, the second radiation element 120, and the third radiation element 130 may substantially have an inverted J-shape, but it is not limited to.

The shape and style of the carrier element 140 are not limited in the invention. The first radiation element 110, the second radiation element 120, and the third radiation element 130 may all be disposed on the same surface of the carrier element 140. For example, the first radiation element 110, the second radiation element 120, and the third radiation element 130 may be formed on the carrier element 140 by using the LDS (Laser Direct Structuring) technology.

In a preferred embodiment, an antenna structure 150 of the wearable device 100 is formed by the first radiation element 110, the second radiation element 120, and the third radiation element 130. Therefore, the wearable device 100 can provide the wireless communication function.

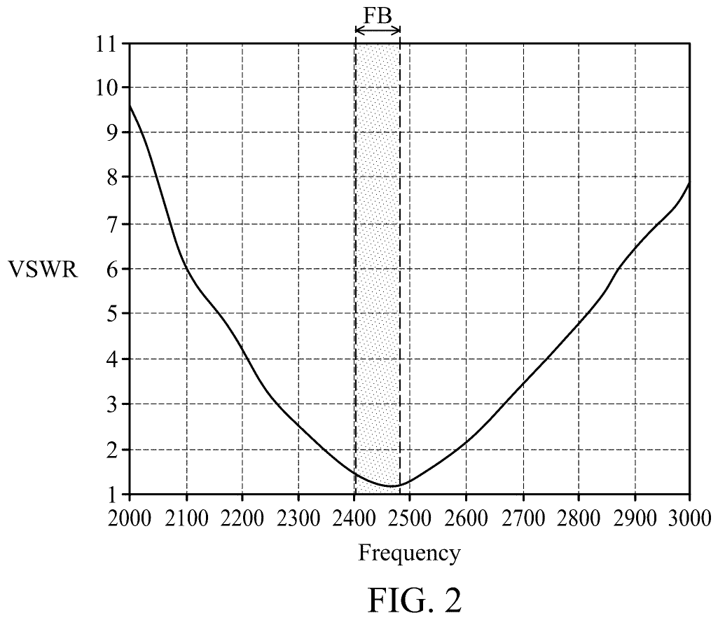

FIG. 2 is a diagram of VSWR (Voltage Standing Wave Ratio) of the antenna structure 150 of the wearable device 100 according to an embodiment of the invention. The horizontal axis represents the operational frequency (MHz), and the vertical axis represents the VSWR. According to the measurement of FIG. 2, the antenna structure 150 of the wearable device 100 can cover an operational frequency band FB. For example, the operational frequency band FB may be from 2402 MHz to 2482 MHz. Therefore, the wearable device 100 can support at least the wideband operations of Bluetooth and WLAN (Wireless Local Area Networks) 2.4 GHz. However, the invention is not limited thereto. In alternative embodiments, the operational frequency band FB further includes a frequency interval from 5150 MHz to 5850 MHz, and another frequency interval from 5925 MHz to 7125 MHz. Thus, the wearable device 100 can also support the wideband operation of Wi-Fi 6E.

In some embodiments, the element sizes of the wearable device 100 will be described as follows. The total length LT of the first radiation element 110, the second radiation element 120, and the third radiation element 130 may be substantially equal to 0.25 wave-length (λ/4) of the operational frequency band FB of the antenna structure 150 of the wearable device 100. The width W1 of the first radiation element 110 may be from 1.5 mm to 2.5 mm, such as about 2 mm. The length L2 of the second radiation element 120 may be from 10.5 mm to 11.5 mm, such as about 11 mm. The width W2 of the second radiation element 120 may be from 1.25 mm to 1.75 mm, such as about 1.5 mm. The width W3 of the third radiation element 130 may be from 2.75 mm to 3.25 mm, such as about 3 mm. The above ranges of element sizes are calculated and obtained according to many experimental results, and they help to optimize the operational bandwidth and the impedance matching of the antenna structure 150 of the wearable device 100.

The following embodiments will introduce different configurations and detail structural features of the wearable device 100. It should be understood that these figures and descriptions are merely exemplary, rather than limitations of the invention.

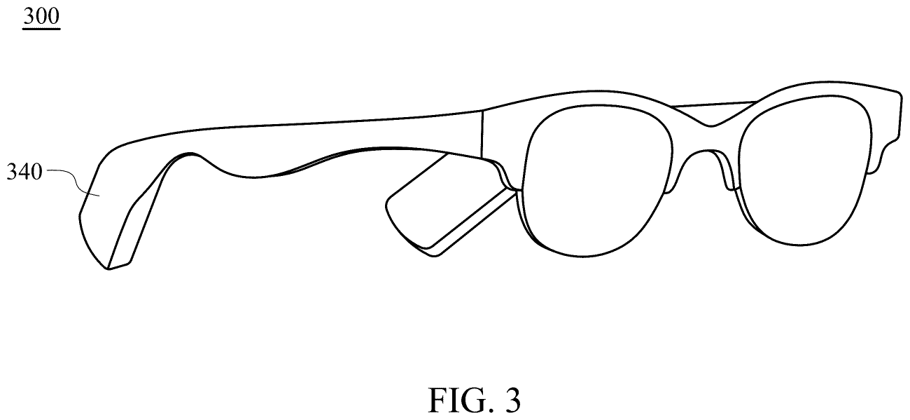

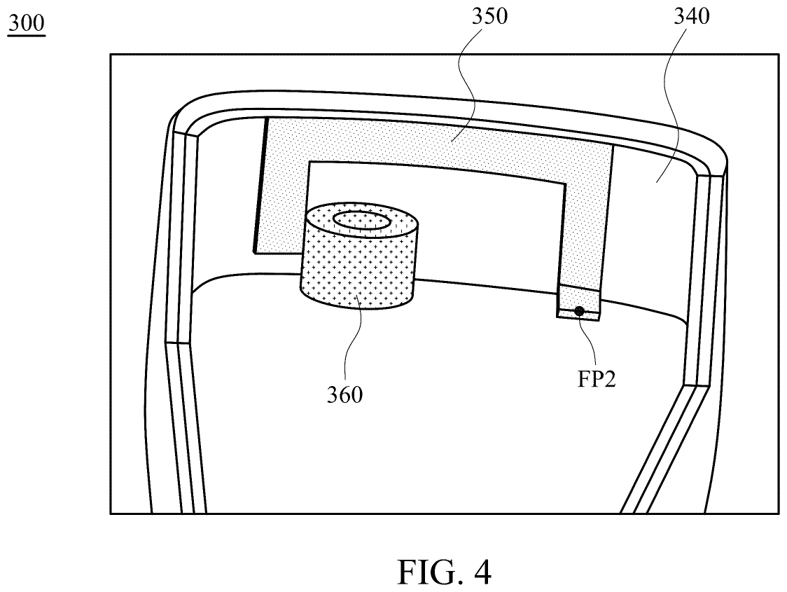

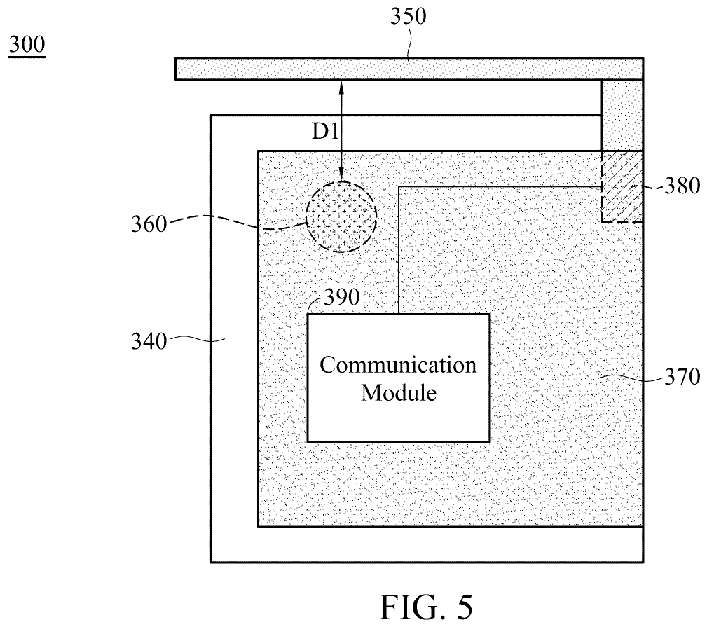

FIG. 3 is a perspective view of a wearable device 300 according to an embodiment of the invention. FIG. 4 is a partial view of the wearable device 300 according to an embodiment of the invention. FIG. 5 is another partial view of the wearable device 300 according to an embodiment of the invention. Please refer to FIG. 3, FIG. 4 and FIG. 5 together. It should be noted that some elements are omitted and not displayed in FIG. 4 and FIG. 5 such that readers can easily understand the invention. In the embodiment of FIG. 3, FIG. 4 and FIG. 5, the wearable device 300 is a pair of smart eyeglasses with the wireless communication function, and a carrier element 340 of the wearable device 300 is the nonconductive temple of the pair of smart eyeglasses. In addition, an antenna structure 350 of the wearable device 300 may be disposed on an internal surface of the carrier element 340, and the internal surface may be a curved surface, but it is not limited thereto.

In some embodiments, the wearable device 300 further includes a screw element 360, a main circuit board 370, and a metal spring 380. The screw element 360 is configured to affix the main circuit board 370. The main circuit board 370 includes a communication module 390, which may be an RF module. The communication module 390 may be coupled through the metal spring 380 to a feeding point FP2 of the antenna structure 350, such that the antenna structure 350 can be excited by the communication module 390. The screw element 360 is adjacent to the antenna structure 350. It should be noted that the term “adjacent” or “close” over the disclosure means that the distance (spacing) between two corresponding elements is smaller than a predetermined distance (e.g., 5 mm or the shorter), but often does not mean that the two corresponding elements directly touch each other (i.e., the aforementioned distance/spacing between them is reduced to 0). For example, the distance D1 between the antenna structure 350 (or its any radiation element) and the screw element 360 may be from 0.1 mm to 0.125 mm. According to practical measurements, such a range of the distance D1 can help to prevent the screw element 360 from negatively affecting the radiation performance of the antenna structure 350 so much, and it can also help to well integrate the antenna structure 350 with the wearable device 300. Other features of the wearable device 300 of FIG. 3, FIG. 4 and FIG. 5 are similar to those of the wearable device 100 of FIG. 1. Thus, the two embodiments can achieve similar levels of performance.

The invention proposes a novel wearable device. In comparison to the conventional design, the invention has at least the advantages of covering the wideband operations, integrating the antenna structure, minimizing the overall antenna size, and reducing the overall manufacturing cost. Therefore, the invention is suitable for application in a variety of small-size wearable devices with communication functions.

Note that the above element sizes, element shapes, and frequency ranges are not limitations of the invention. An antenna designer can fine-tune these settings or values according to different requirements. It should be understood that the wearable device of the invention is not limited to the configurations of FIGS. 1-5. The invention may merely include any one or more features of any one or more embodiments of FIGS. 1-5. In other words, not all of the features displayed in the figures should be implemented in the wearable device of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wearable device, comprising:
a first radiation element, having a feeding point;
a second radiation element, coupled to the first radiation element;
a third radiation element, coupled to the second radiation element; and
a carrier element, wherein the first radiation element, the second radiation element, and the third radiation element are disposed on the carrier element;
wherein an antenna structure is formed by the first radiation element, the second radiation element, and the third radiation element.

2. The wearable device as claimed in claim 1, wherein the wearable device is a pair of smart eyeglasses with a wireless communication function.

3. The wearable device as claimed in claim 2, wherein the carrier element is a nonconductive temple of the pair of smart eyeglasses.

4. The wearable device as claimed in claim 1, wherein the third radiation element is substantially parallel to the first radiation element.

5. The wearable device as claimed in claim 1, wherein the second radiation element is substantially perpendicular to the first radiation element and the third radiation element.

6. The wearable device as claimed in claim 1, wherein a length of the second radiation element is greater than that of the first radiation element.

7. The wearable device as claimed in claim 1, wherein a length of the first radiation element is greater than that of the third radiation element.

8. The wearable device as claimed in claim 1, wherein the antenna structure covers an operational frequency band, and the operational frequency band is from 2402 MHz to 2482 MHz.

9. The wearable device as claimed in claim 8, wherein a total length of the first radiation element, the second radiation element, and the third radiation element is substantially equal to 0.25 wavelength of the operational frequency band.

10. The wearable device as claimed in claim 1, further comprising:
a main circuit board, comprising a communication module, wherein the communication module is coupled to the feeding point; and
a screw element, configured to affix the main circuit board, wherein a distance between the antenna structure and the screw element is from 0.1 mm to 0.125 mm.
